(19) United States
(12) Patent Application Publication
(10) Pub. No.: US 2017/0132055 A1
(43) Pub. Date: May 11, 2017

(54) Determining Physical Layer Error Signatures of a Communications Link

(71) Applicants: Hui Wu, Cupertino, CA (US); Yaochao Yang, Fremont, CA (US); Mike Sapozhnikov, San Jose, CA (US); Stephen Kolecki, Austin, TX (US)

(72) Inventors: Hui Wu, Cupertino, CA (US); Yaochao Yang, Fremont, CA (US); Mike Sapozhnikov, San Jose, CA (US); Stephen Kolecki, Austin, TX (US)

(73) Assignee: Cisco Technology, Inc., a corporation of California, San Jose, CA (US)

(21) Appl. No.: 14/938,819

(22) Filed: Nov. 11, 2015

(51) Int. Cl. G06F 11/07; H04L 1/00; H04L 25/03

(52) U.S. Cl. CPC G06F 11/076; H04L 25/03197; G06F 11/0709; G06F 11/0787; H04L 1/0045

(57) ABSTRACT

In one embodiment, physical layer error signatures of a communications link are determined by ascertaining characteristics of erred and correct modulation symbols received by a physical receiver of a communications device, such as, but not limited to, by a receiver of a packet switching device in a communications network normally used to receive data traffic. In one embodiment, a physical receiver of a physical communications device receives a particular modulation symbol and determines whether the received particular modulation symbol is an expected modulation symbol in a predetermined sequence of modulation symbols. One or more storage devices are maintained with one or more error signature measurements based on determining whether the particular modulation symbol is the expected modulation symbol in the predetermined sequence of modulation symbols, with the error signature measurements including performing a comparison to a threshold value or a current maximum value.

### TECHNICAL FIELD

The present disclosure relates generally to determining physical layer error signatures of a communications link by ascertaining characteristics of erred and correct modulation symbols received by a physical receiver of a communications device, such as, but not limited to, modulation symbols received by the same receiver of a packet switching device in a communications network normally used to receive data traffic.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). Successful signal transmission in communication, computing, storage and other systems typically requires low error events through transmission.

### BRIEF DESCRIPTION OF THE DRAWINGS

The appended claims set forth the features of one or more embodiments with particularity. The embodiment(s), together with its advantages, may be understood from the following detailed description taken in conjunction with the accompanying drawings of which:

FIG. 1A illustrates receiver(s) operating according to one embodiment;

FIG. 1B illustrates a process according to one embodiment;

FIG. 1C illustrates a process according to one embodiment;

FIG. 2A illustrates receiver(s) operating according to one embodiment;

FIG. 2B illustrates a process according to one embodiment;

FIG. 3A illustrates receiver(s) operating according to one embodiment;

FIG. 3B illustrates a process according to one embodiment;

FIG. 4A illustrates receiver(s) operating according to one embodiment;

FIG. 4B illustrates a process according to one embodiment;

FIG. 5A illustrates receiver(s) operating according to one embodiment;

FIG. 5B illustrates a process according to one embodiment;

FIG. 6A illustrates a packet switching device according to one embodiment; and

FIG. 6B illustrates an apparatus according to one embodiment.

### DESCRIPTION OF EXAMPLE EMBODIMENTS

### 1. Overview

Disclosed are, inter alia, methods, apparatus, computer-storage media, mechanisms, and means associated with determining physical layer error signatures of a communications link by ascertaining characteristics of erred and correct modulation symbols received by a physical receiver of a communications device, such as, but not limited to, modulation symbols received by the same receiver of a packet switching device in a communications network normally used to receive data traffic. In one embodiment, for each particular modulation symbol of a plurality of modulation symbols: a physical receiver of a physical communications device receives the particular modulation symbol and determines whether the received particular modulation symbol is an expected modulation symbol in a predetermined sequence of a plurality of predetermined modulation symbols. One or more storage devices are maintained with one or more error signature measurements based on determining whether the particular modulation symbol is the expected modulation symbol in the predetermined sequence of the plurality of predetermined modulation symbols, with the error signature measurements including performing a comparison to a threshold value or a current maximum value.

### 2. Description

Disclosed are, inter alia, methods, apparatus, computer-storage media, mechanisms, and means associated with determining physical layer error signatures of a communications link. Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, test equipment, methods, and computer-readable media containing instructions. One or multiple systems, devices, components, etc., may comprise one or more embodiments, which may include some elements or limitations of a claim being performed by the same or different systems, devices, components, etc. A processor may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The term “route” is used to refer to a fully or partially expanded prefix (e.g., 10.0.0.1 or 10.0.*.*), which is different than a “path” through the network which refers to a nexthop (e.g., next router) or complete path (e.g., traverse router A then router B, and so on). Also, the use of the term “prefix” without a qualifier herein refers to a fully or partially expanded prefix.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “particular,” “first,” “second,” etc., are typically used herein to denote different units (e.g., a particular element, a first element, a second element). The use of these terms herein does not necessarily connote an ordering such as one unit or event occurring or coming before another, but rather provides a mechanism to distinguish between individual units and per antecedent basis principles, for example, “a particular unit” and “the particular unit” refer to the same identifiable unit, and not two different units.

Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

Disclosed are, inter alia, methods, apparatus, computer-storage media, mechanisms, and means associated with determining physical layer error signatures of a communications link by ascertaining characteristics of erred and correct modulation symbols received by a physical receiver of a communications device, such as, but not limited to, by a receiver of a packet switching device in a communications network normally used to receive data traffic. By ascertaining these characteristics using an actual physical receiver that will be used to receive data traffic, characterizations of link errors are ascertained that are more likely to mimic those errors when data traffic is communicated over the link to the receiver.

Signal transmission occurs in the physical layer, and usually involves a transmitter which sends out a modulation symbol stream. As used herein, a modulation symbol is defined at the physical layer for signal modulation, concerning the physical properties of signal such as amplitude, phase, frequency, and timing, etc. A modulation symbol may represent one, two or more bits depending on the modulation scheme. A modulation symbol does not refer to a symbol defined at the link layer or above. Further, as used herein, a “link” refers to a wired (e.g., electrical, optical) or wireless channel from which a physical receiver receives a modulation symbol.

One embodiment includes a method, comprising: for each particular modulation symbol of a plurality of modulation symbols: receiving, by a physical receiver of a physical communications device, said particular modulation symbol; determining whether said particular modulation symbol is an expected modulation symbol in a predetermined sequence of a plurality of predetermined modulation symbols; and maintaining one or more storage devices with one or more error signature measurements based on said determining whether said particular modulation symbol is the expected modulation symbol in the predetermined sequence of the plurality of predetermined modulation symbols, with said error signature measurements including performing a comparison to a threshold value or a current maximum value.

In one embodiment, the physical communications device is a router. In one embodiment, said maintaining one or more storage devices with one or more error signature measurements includes totaling the number of errors between a received modulation symbol and a corresponding expected modulation symbol, and in response to said totaled number of errors equaling or exceeding a threshold value, increasing a corresponding counter. In one embodiment, said maintaining one or more storage devices with one or more error signature measurements includes resetting the number of errors between a received modulation symbol and a corresponding expected modulation symbol in response to said received modulation symbols of a plurality of modulation symbols equaling or exceeding a predetermined block size. In one embodiment, the predetermined block size is the size of a frame of modulation symbols used by a forward error correction (FEC) code for encoding and decoding purposes. In one embodiment, the threshold value is the maximum number of correctable errors for the frame. One embodiment includes recording a snapshot of a portion of the plurality of modulation symbols said received by the physical receiver in response to a triggering event based on said totaled number of errors equaling or exceeding the threshold value. In one embodiment, said maintaining one or more storage devices with one or more error signature measurements includes storing a maximum number of said totaled number of errors.

In one embodiment, said maintaining one or more storage devices with one or more error signature measurements includes totaling the number of errors between a received modulation symbol and a corresponding expected modulation symbol, comparing said totaled number of errors to a plurality of threshold values, and increasing a corresponding counter for said totaled number of errors equaling or exceeding a corresponding threshold value of the plurality of threshold values.

In one embodiment, said maintaining one or more storage devices with one or more error signature measurements includes totaling the number of consecutive errors between a received modulation symbol and a corresponding expected modulation symbol, and in response to said totaled number of consecutive errors equaling or exceeding a threshold value, increasing a corresponding counter, and with said consecutive errors being a sequence of consecutive errors with the number of consecutive errors being at least a predetermined consecutive number greater than one. In one embodiment, said maintaining one or more storage devices with one or more error signature measurements includes resetting the number of consecutive errors in response to said received modulation symbols of a plurality of modulation symbols equaling or exceeding a predetermined block size. In one embodiment, the predetermined block size is the size of a frame of modulation symbols used by a forward error correction (FEC) code for encoding and decoding purposes. In one embodiment, said maintaining one or more storage devices with one or more error signature measurements includes storing a maximum number of said number of consecutive errors.

In one embodiment, said maintaining one or more storage devices with one or more error signature measurements includes totaling the number of consecutive errors between a received modulation symbol and a corresponding expected modulation symbol, comparing said totaled number of errors to a plurality of threshold values, and increasing a corresponding counter for said totaled number of consecutive errors equaling or exceeding a corresponding threshold value of the plurality of threshold values, and with said consecutive errors being a sequence of consecutive errors with the number of consecutive errors being at least a predetermined consecutive number greater than one.

One embodiment includes recording a snapshot of a portion of the plurality of modulation symbols said received by the physical receiver in response to a triggering event based on said determining operation for one or more modulation symbols of the plurality of modulation symbols said received by the physical receiver. In one embodiment, the snapshot includes at least one received modulation symbol of a plurality of modulation symbols prior to the last received modulation symbol of a plurality of modulation symbols causing the triggering event.

In one embodiment, said maintaining one or more storage devices with one or more error signature measurements includes comparing a predetermined error pattern with a received error pattern, with the received error pattern determined by comparing consecutively received modulation symbols and corresponding expected modulation symbols, and in response to the predetermined error pattern matching the received error pattern recording an indication of the predetermined error pattern matching the received error pattern.

One embodiment includes a packet switching device, comprising: a plurality of physical interfaces configured to send and receive packets; and one or more packet switching mechanisms configured to packet switch packets among said physical interfaces, with at least one of said physical interfaces includes a physical receiver configured to perform testing operations. In one embodiment, these testing operations include for each particular modulation symbol of a plurality of modulation symbols: receiving, by a physical receiver of a physical communications device, said particular modulation symbol; determining whether said particular modulation symbol is an expected modulation symbol in a predetermined sequence of a plurality of predetermined modulation symbols; and maintaining one or more storage devices with one or more error signature measurements based on said determining whether said particular modulation symbol is the expected modulation symbol in the predetermined sequence of the plurality of predetermined modulation symbols, with said error signature measurements including performing a comparison to a threshold value or a current maximum value.

One embodiment includes a method, comprising: for each particular modulation symbol of a plurality of modulation symbols: receiving, by a physical receiver of a physical communications device, said particular modulation symbol; determining whether said particular modulation symbol is an expected modulation symbol in a predetermined sequence of a plurality of predetermined modulation symbols; and maintaining one or more storage devices with one or more error signature measurements based on said determining whether said particular modulation symbol is the expected modulation symbol in the predetermined sequence of the plurality of predetermined modulation symbols, with said error signature measurements recording a snapshot of a portion of the plurality of modulation symbols said received by the physical receiver in response to a triggering event based on said determining operation for one or more modulation symbols of the plurality of modulation symbols said received by the physical receiver. In one embodiment, the snapshot includes at least one received modulation symbol of a plurality of modulation symbols prior to the last received modulation symbol of a plurality of modulation symbols causing the triggering event.

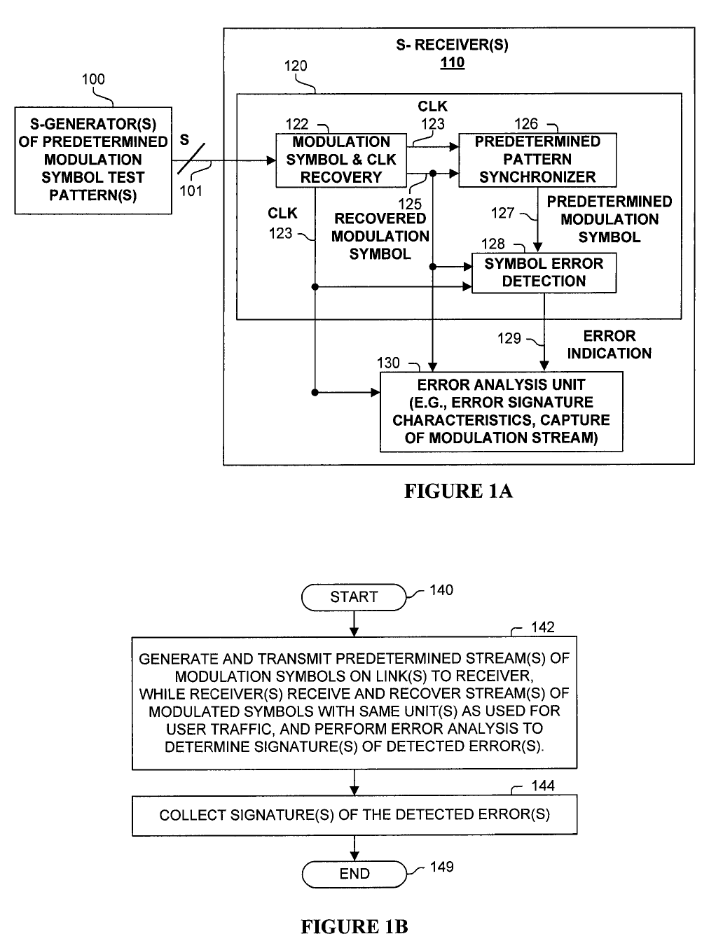

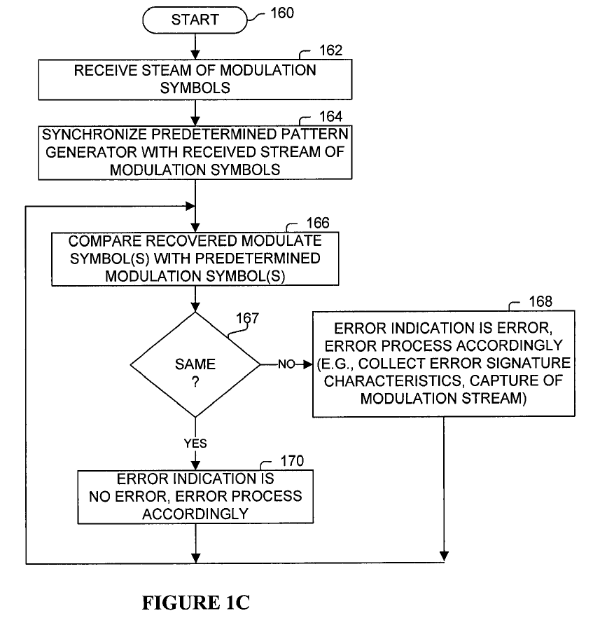

FIG. 1A illustrates one or more receivers 110 operating according to one embodiment. Represented are S test generators 100 and S receivers 100 communicatively coupled over S links 101, with S being a positive integer. Each of S test generators 100 generate a predetermined sequence of modulation symbols (e.g., a modulation symbol stream) which are communicated over S links 101 to S receivers 100. Each of S receivers 100 receives and recovers the corresponding predetermined sequence of modulation symbols and which is compared to the expected sequence of modulation symbols in block 120. Error analysis unit 130 of each receiver 100 collects information about the differences between the received and expected streams of modulation symbols.

In one embodiment, recovery and comparison block 120 includes a modulation symbol and clock recovery unit 122, which generates clock 123 and recovered modulation symbols 125. Predetermined pattern synchronizer 126 synchronizes modulation symbols of an expected stream of modulation symbols and generates the synchronized expected stream of modulation symbols 127. In one embodiment, a same repeating pseudorandom binary sequence is sent by each of S test generators 100 and predetermined pattern synchronizer 126. Because such stream is repeating and known beforehand, predetermined pattern synchronizer 126 synchronizes typically within a small number of recovered modulation symbols 125. Symbol error detection compares received and expected modulation symbols (125, 128) and generates an error indication 129 (e.g., match or does not match).

In one embodiment, error analysis unit 130 receives clock 123, recovered modulation symbol 130, and error indication 129. In one embodiment, error analysis unit 130 does not receive recovered modulation symbol 130 (as, for example, no logging of the received modulation stream is performed). Error analysis unit 130 determines and collects error signature information for the recovered modulation symbols 125 as signaled by error indications 129. This determined and recovered error signature information retrieved by a controller or network management system and further analyzed to check the performance of the S links 101 coupled to S receivers 100.

FIG. 1B illustrates a testing-mode process according to one embodiment. Processing begins with process block 140. In process block 142, the predetermined stream(s) of modulation symbols are generated and communicated over links to the receiver(s). The receiver(s) receive and recover the stream(s) of modulation symbols and compare to expected stream(s) of modulation symbols and generate error indications for each of the recovered stream(s) of modulation symbols. In one embodiment, the link(s) and receiver(s) are the same link(s) and receiver(s) that will be used for live data traffic when in operational mode (e.g., not different link(s) and receiver(s) only used for testing purposes). In process block 144, signature(s) of the detected error(s) are collected. Processing of the flow diagram of FIG. 1B is complete as represented by process block 149.

FIG. 1C illustrates a process according to one embodiment. Processing begins with process block 160. In process block 162, a stream of modulation symbols is received by a receiver. In process block 164, the expected predetermined stream of modulation symbols is synchronized to the received stream of modulation symbols. Received and expected modulation symbols are compared. As determined in process block 167, if they are the same (e.g., no error), then in process block 170 the error indication is no error; else in process block 168 the error indication is error. Error processing is performed accordingly in each of process blocks 168 and 170 to collected signature information about received stream of modulation symbols. Processing returns to process block 166 to compare more received and expected modulation symbols.

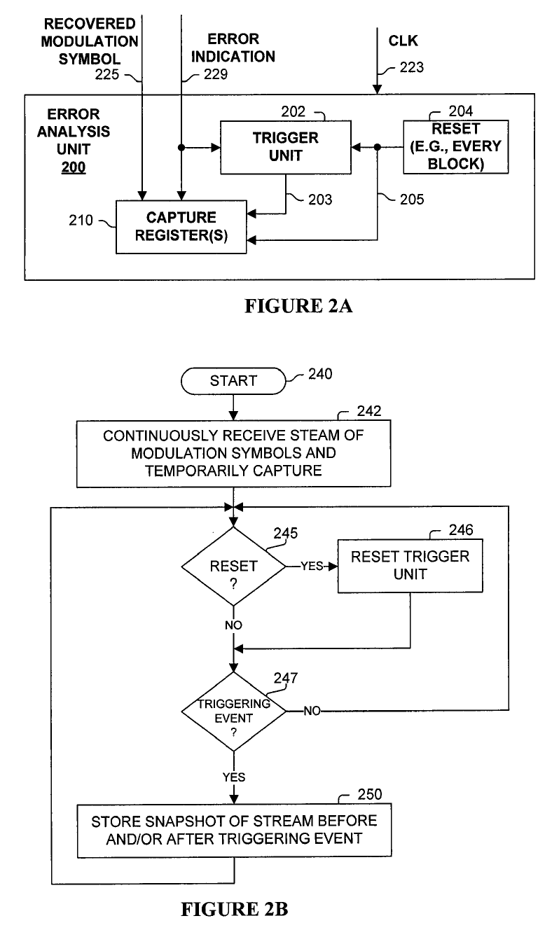

FIGS. 1A-C illustrated portions of one embodiment, which may include aspects of more than one of FIGS. 1A-C. FIGS. 2A-6B illustrate portions of one embodiment, which may include aspects of more than one of FIGS. 2A-6B. In particular, FIGS. 2A-5B illustrate different aspects of an error analysis unit (130 of FIG. 1A), which collects signature information according to one embodiment.

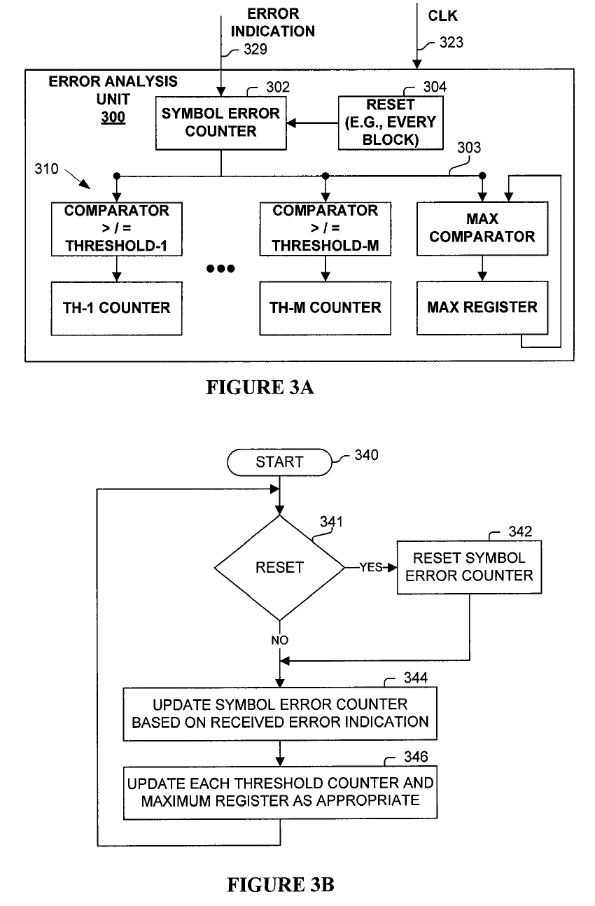

FIG. 2A illustrates an error analysis unit 200 used to determine and collect signature information for a receiver in one embodiment, with this signature information including a snapshot one or more recovered modulation symbols 225 in capture register(s) 210. Trigger unit 202 determines which portion of the recovered modulation symbols 225 to capture (and typically also captures at least a portion of the sequence of error indications 229) and accordingly generates a trigger signal 203, with this captured portion possibly including recovered modulation symbols 225 buffered in register(s) 210 prior to the triggering event. In one embodiment, error analysis unit 200 performs its signature analysis on a per block basis, with a block being defined as a predetermined number of recovered modulation symbols 225 with reset unit 204 accordingly generating reset signal 205. For example in one embodiment, a block corresponds to a number of bits or modulation symbols used by a forward error correction (FEC) frame used in encoding or decoding. In one embodiment, the frame is an FEC codeword. In one embodiment, a frame is a group of two or more bits or modulation symbols. In one embodiment, the triggering event is the maximum number, or one more than the maximum number, of bits or modulation symbols that could be corrected by the FEC. In one embodiment, the triggering event is a different number, which is either smaller or larger than this maximum number. In one embodiment, the triggering event corresponds to one or more of the signature collection aspects discussed in relation to FIGS. 3A-5B.

FIG. 2B illustrates a process according to one embodiment. Processing begins with process block 240. In process block 242, the error analysis unit continuously receives a recovered stream of modulation symbols which are buffered. As determine in process block 245, if a reset is encountered (e.g., for a block or other size), then in process block 246 the triggering unit is reset. Next as determined in process block 247, if the triggering event has occurred, then in process block 250 a snapshot of a portion of, or the entire recovered stream of modulation symbols is stored (and later retrieved by a controller or network management system). Processing of the flow diagram of FIG. 2B returns to process block 245.

FIG. 3A illustrates an error analysis unit 300 used to determine and collect signature information for a receiver in one embodiment based on received error indications 329 (corresponding to a comparison of recovered and expected modulation symbols) and clock 323. In one embodiment, a symbol error counter 302 is updated based on error indications 329, and possibly reset on a per block or other basis as controlled by reset unit 304. Based on the current value of symbol error counter 302, signature information is collected by units 310 which typically include one or more comparators with predetermined thresholds and counters, and a maximum register and counter to determine the maximum value of symbol error counter 302 during a test. These collected values are later retrieved by a controller or network management system. In one embodiment, the threshold values correspond to the number of correctable bits or modulation symbols by forward error correction techniques, which may include having symbol error counter 302 reset on a per block basis.

FIG. 3B illustrates a process according to one embodiment. Processing begins with process block 340. As determined in process block 341, if the symbol error counter should be reset (e.g., according to a block size or other number of recovered symbols), then in process block 342 the symbol error counter is reset. In process block 344, the symbol error counter is updated. In process block 346, each threshold counter and maximum register is updated accordingly. Processing returns to process block 341.

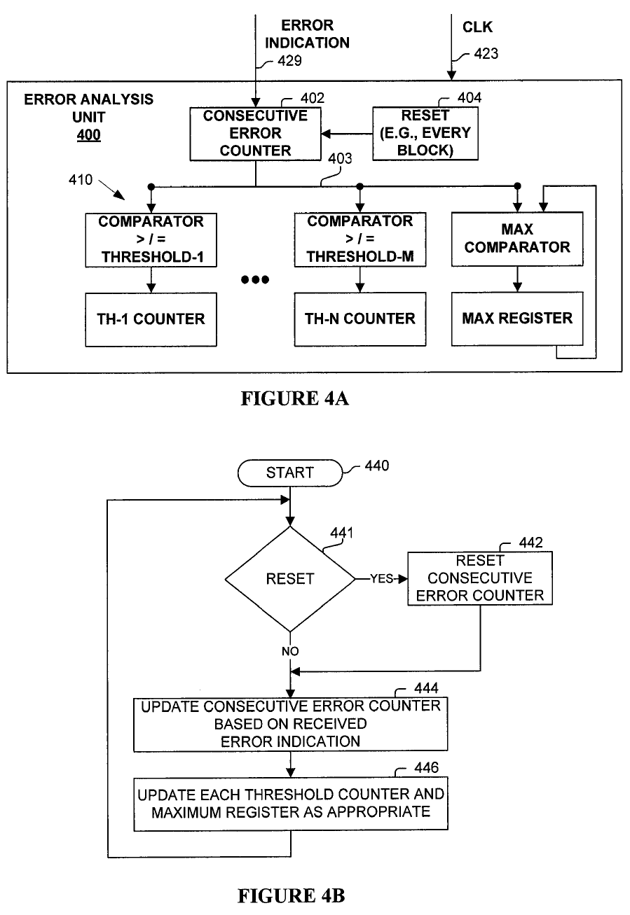

FIG. 4A illustrates an error analysis unit 400 used to determine and collect signature information for a receiver in one embodiment based on received error indications 429 (corresponding to a comparison of recovered and expected modulation symbols) and clock 423. Consecutive error counter is updated based on error indications 429. As used herein, a consecutive error is defined as the current number of indications of errors in a row according to error indications 429. In one embodiment, consecutive error counter 402 is reset on a per block or other basis as controlled by reset unit 404. Based on the current value of consecutive error counter 402, signature information is collected by units 410 which typically include one or more comparators with predetermined thresholds and counters, and a maximum register and counter to determine the maximum value of consecutive error counter 402 during a test. These collected values are later retrieved by a controller or network management system.

FIG. 4B illustrates a process according to one embodiment. Processing begins with process block 440. As determined in process block 441, if the consecutive error counter should be reset (e.g., according to a block size or other number of recovered symbols), then in process block 442 the consecutive error counter is reset. In process block 444, the consecutive error counter is updated. In process block 446, each threshold counter and maximum register is updated accordingly. Processing returns to process block 441.

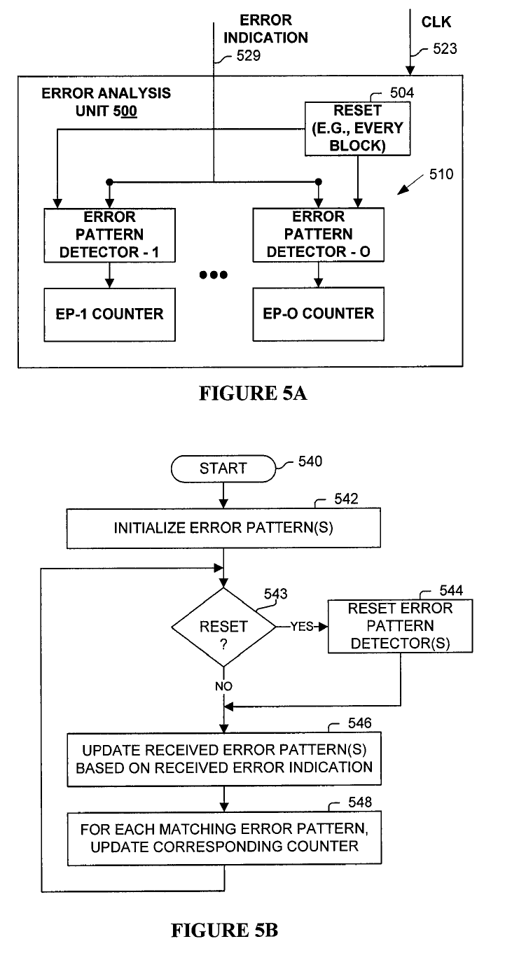

FIG. 5A illustrates an error analysis unit 500 used to determine and collect signature information for a receiver in one embodiment based on received error indications 529 (corresponding to a comparison of recovered and expected modulation symbols) and clock 523. Each of error pattern detectors (having corresponding counters) 510 are programmed by a controller or network management system with a predetermined error pattern of error indications 529 to match against. In one embodiment, each of error pattern detectors (510 but not their counters) is reset on a per block or other basis as controlled by reset unit 504. Based on whether the predetermined error pattern is matched, a corresponding error counter (510) is updated. These counter values are later retrieved by a controller or network management system.

FIG. 5B illustrates a process according to one embodiment. Processing begins with process block 540. In process block 542, each of one or more error pattern matching units are initialized with a predetermined pattern to match against. As determined in process block 543, if the error pattern detectors should be reset (e.g., according to a block size or other number of recovered symbols), then in process block 544 each of the error pattern detectors is reset. In process block 546, each of the one or more error pattern detectors is updated based on the received error indication. In process block 548, each counter is updated if a predetermined error pattern is matched. Processing returns to process block 543.

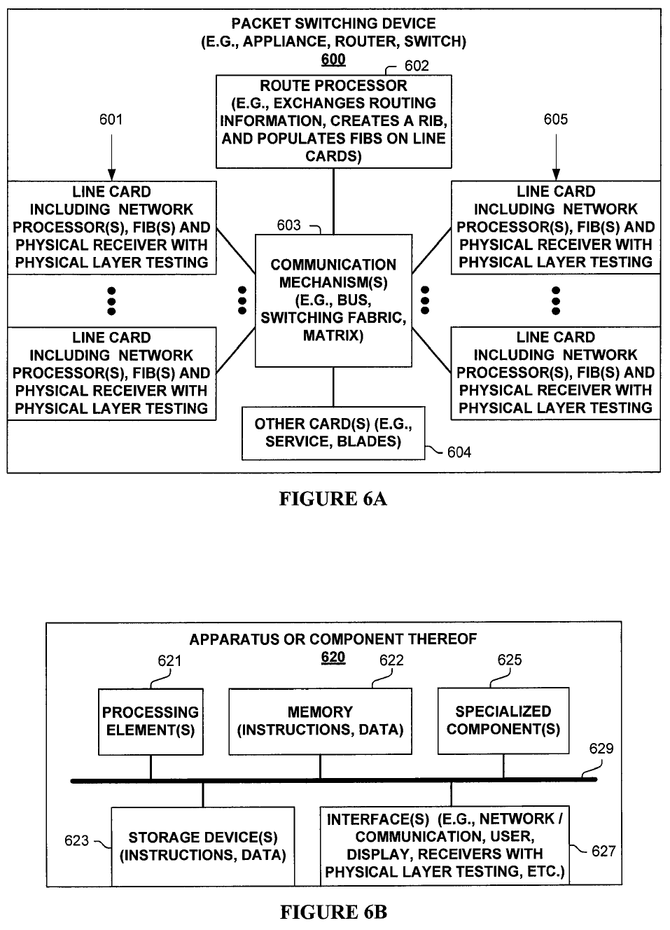

One embodiment of a packet switching device 600 with monitoring points on line cards and/or interfaces is illustrated in FIG. 6A. In one embodiment, a monitoring point is a flow monitoring engine including a processor or specialized hardware to monitor flows of packets. As shown, packet switching device 600 includes multiple line cards 601 and 605, each with one or more network interfaces for sending and receiving packets over communications links (e.g., possibly part of a link aggregation group), and with one or more processors that are used in one embodiment associated with determining physical layer error signatures of a communications link. Packet switching device 600 also has a control plane with one or more processors 602 for managing the control plane and/or control plane processing of packets associated with determining physical layer error signatures of a communications link. In one embodiment, route processor 602 exchanges routing information with other packet switching devices and according maintains a routing information base (RIB). Based on the RIB, packet forwarding information is derived and populated in forwarding information bases (FIBs) on line cards 601, 605. Packet switching device 600 also includes other cards 604 (e.g., service cards, blades) which include processors that are used in one embodiment to process packets with selective configuring of throttling engines for flows of packet traffic, and some communication mechanism 603 (e.g., bus, switching fabric, matrix) for allowing its different entities 601, 602, 604 and 605 to communicate.

Line cards 601 and 605 typically perform the actions of being both an ingress and egress line card, in regards to multiple other particular packets and/or packet streams being received by, or sent from, packet switching device 600. In one embodiment, line cards 601 and/or 605 use command message generation and execution using a machine code-instruction to perform prefix or other address matching on forwarding information bases (FIBs) to determine how to ingress and/or egress process packets. Even though the term FIB includes the word “forwarding,” this information base typically includes other information describing how to process corresponding packets.

In one embodiment, the analysis of which interfaces can receive an identified flow of packet traffic is performed by each individual line card 601, 605, possibly singularly or for multiple network processor units, etc. In one embodiment, the analysis of which interfaces can receive an identified flow of packet traffic is performed by route processor 602.

In one embodiment, line cards 601 and 605 include receivers with error analysis units for testing received streams of modulation symbols, such as, but not limited to, as described herein including according to FIGS. 1A-5B.

FIG. 6B is a block diagram of an apparatus 620 used in one embodiment associated with determining physical layer error signatures of a communications link. In one embodiment, apparatus 620 performs one or more processes, or portions thereof, corresponding to one of the flow diagrams illustrated or otherwise described herein, and/or illustrated in another diagram or otherwise described herein. In one embodiment, these processes are performed in one or more threads on one or more processors.

In one embodiment, apparatus 620 includes one or more processor(s) 621 (typically with on-chip memory), memory 622, storage device(s) 623, specialized component(s) 625 (e.g., ternary content-addressable memory(ies) such as for performing flow identification packet processing operations, flow monitoring, etc.), and interface(s) 627 for communicating information (e.g., sending and receiving packets, user-interfaces, displaying information, etc.), which are typically communicatively coupled via one or more communications mechanisms 629 (e.g., bus, links, switching fabric, matrix), with the communications paths typically tailored to meet the needs of a particular application.

In one embodiment, interfaces 627 include receivers with error analysis units for testing received streams of modulation symbols, such as, but not limited to, as described herein including according to FIGS. 1A-5B.

Various embodiments of apparatus 620 may include more or fewer elements. The operation of apparatus 620 is typically controlled by processor(s) 621 using memory 622 and storage device(s) 623 to perform one or more tasks or processes. Memory 622 is one type of computer-readable/computer-storage medium, and typically comprises random access memory (RAM), read only memory (ROM), flash memory, integrated circuits, and/or other memory components. Memory 622 typically stores computer-executable instructions to be executed by processor(s) 621 and/or data which is manipulated by processor(s) 621 for implementing functionality in accordance with an embodiment. Storage device(s) 623 are another type of computer-readable medium, and typically comprise solid state storage media, disk drives, diskettes, networked services, tape drives, and other storage devices. Storage device(s) 623 typically store computer-executable instructions to be executed by processor(s) 621 and/or data which is manipulated by processor(s) 621 for implementing functionality in accordance with an embodiment.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
for each particular modulation symbol of a plurality of modulation symbols:
receiving, by a physical receiver of a physical communications device, said particular modulation symbol;
determining whether said particular modulation symbol is an expected modulation symbol in a predetermined sequence of a plurality of predetermined modulation symbols; and
maintaining one or more storage devices with one or more error signature measurements based on said determining whether said particular modulation symbol is the expected modulation symbol in the predetermined sequence of the plurality of predetermined modulation symbols, with said error signature measurements including performing a comparison to a threshold value or a current maximum value.

2. The method of claim 1, wherein the physical communications device is a router.

3. The method of claim 1, wherein said maintaining one or more storage devices with one or more error signature measurements includes totaling the number of errors between a received modulation symbol and a corresponding expected modulation symbol, and in response to said totaled number of errors equaling or exceeding a threshold value, increasing a corresponding counter.

4. The method of claim 3, wherein said maintaining one or more storage devices with one or more error signature measurements includes resetting the number of errors between a received modulation symbol and a corresponding expected modulation symbol in response to said received modulation symbols of a plurality of modulation symbols equaling or exceeding a predetermined block size.

5. The method of claim 4, wherein the predetermined block size is the size of a frame of modulation symbols used by a forward error correction (FEC) code for encoding and decoding purposes.

6. The method of claim 5, wherein the threshold value is the maximum number of correctable errors for the frame.

7. The method of claim 6, comprising recording a snapshot of a portion of the plurality of modulation symbols said received by the physical receiver in response to a triggering event based on said totaled number of errors equaling or exceeding the threshold value.

8. The method of claim 7, wherein said maintaining one or more storage devices with one or more error signature measurements includes storing a maximum number of said totaled number of errors.

9. The method of claim 1, wherein said maintaining one or more storage devices with one or more error signature measurements includes totaling the number of errors between a received modulation symbol and a corresponding expected modulation symbol, comparing said totaled number of errors to a plurality of threshold values, and increasing a corresponding counter for said totaled number of errors equaling or exceeding a corresponding threshold value of the plurality of threshold values.

10. The method of claim 1, wherein said maintaining one or more storage devices with one or more error signature measurements includes totaling the number of consecutive errors between a received modulation symbol and a corresponding expected modulation symbol, and in response to said totaled number of consecutive errors equaling or exceeding a threshold value, increasing a corresponding counter, and with said consecutive errors being a sequence of consecutive errors with the number of consecutive errors being at least a predetermined consecutive number greater than one.

11. The method of claim 10, wherein said maintaining one or more storage devices with one or more error signature measurements includes resetting the number of consecutive errors in response to said received modulation symbols of a plurality of modulation symbols equaling or exceeding a predetermined block size.

12. The method of claim 11, wherein the predetermined block size is the size of a frame of modulation symbols used by a forward error correction (FEC) code for encoding and decoding purposes..

13. The method of claim 11, wherein said maintaining one or more storage devices with one or more error signature measurements includes storing a maximum number of said number of consecutive errors.

14. The method of claim 1, wherein said maintaining one or more storage devices with one or more error signature measurements includes totaling the number of consecutive errors between a received modulation symbol and a corresponding expected modulation symbol, comparing said totaled number of errors to a plurality of threshold values, and increasing a corresponding counter for said totaled number of consecutive errors equaling or exceeding a corresponding threshold value of the plurality of threshold values, and with said consecutive errors being a sequence of consecutive errors with the number of consecutive errors being at least a predetermined consecutive number greater than one.

15. The method of claim 1, comprising recording a snapshot of a portion of the plurality of modulation symbols said received by the physical receiver in response to a triggering event based on said determining operation for one or more modulation symbols of the plurality of modulation symbols said received by the physical receiver.

16. The method of claim 15, wherein the snapshot includes at least one received modulation symbol of a plurality of modulation symbols prior to the last received modulation symbol of a plurality of modulation symbols causing the triggering event.

17. The method of claim 1, wherein said maintaining one or more storage devices with one or more error signature measurements includes comparing a predetermined error pattern with a received error pattern, with the received error pattern determined by comparing consecutively received modulation symbols and corresponding expected modulation symbols, and in response to the predetermined error pattern matching the received error pattern recording an indication of the predetermined error pattern matching the received error pattern.

18. A packet switching device, comprising:
a plurality of physical interfaces configured to send and receive packets; and
one or more packet switching mechanisms configured to packet switch packets among said physical interfaces;
wherein at least one of said physical interfaces includes a physical receiver configured to perform testing operations, including for each particular modulation symbol of a plurality of modulation symbols:
receiving, by a physical receiver of a physical communications device, said particular modulation symbol;
determining whether said particular modulation symbol is an expected modulation symbol in a predetermined sequence of a plurality of predetermined modulation symbols; and
maintaining one or more storage devices with one or more error signature measurements based on said determining whether said particular modulation symbol is the expected modulation symbol in the predetermined sequence of the plurality of predetermined modulation symbols, with said error signature measurements including performing a comparison to a threshold value or a current maximum value.

19. A method, comprising:
for each particular modulation symbol of a plurality of modulation symbols:
receiving, by a physical receiver of a physical communications device, said particular modulation symbol;
determining whether said particular modulation symbol is an expected modulation symbol in a predetermined sequence of a plurality of predetermined modulation symbols; and
maintaining one or more storage devices with one or more error signature measurements based on said determining whether said particular modulation symbol is the expected modulation symbol in the predetermined sequence of the plurality of predetermined modulation symbols, with said error signature measurements recording a snapshot of a portion of the plurality of modulation symbols said received by the physical receiver in response to a triggering event based on said determining operation for one or more modulation symbols of the plurality of modulation symbols said received by the physical receiver.

20. The method of claim 19, wherein the snapshot includes at least one received modulation symbol of a plurality of modulation symbols prior to the last received modulation symbol of a plurality of modulation symbols causing the triggering event.
